(19) United States
(12) Patent Application Publication
(10) Pub. No.: US 2026/0336040 A1
(43) Pub. Date: Oct. 29, 2026

(54) SOLDER PASTE

(71) Applicant: MITSUBISHI MATERIALS CORPORATION, Tokyo (JP)

(72) Inventor: Shujie Fei, Sanda-shi (JP)

(73) Assignee: MITSUBISHI MATERIALS CORPORATION, Tokyo (JP)

(21) Appl. No.: 19/099,060

(22) PCT Filed: Jun. 7, 2023
(86) PCT No.: PCT/JP2023/021194

§ 371 Date: Jan. 28, 2025

(51) Int. Cl. B23K 35/36; B23K 35/26; B23K 35/30

(52) U.S. Cl. CPC B23K 35/36; B23K 35/262; B23K 35/302; B23K 35/3093

(57) ABSTRACT

The solder paste includes a metal powder, a resin, a solvent, and a thixotropic agent, and has a loss tangent at a strain of 0.01% in a range of 0.1 or more and 0.5 or less. In a case where the loss tangent at a strain of 0.01% is denoted as N₀, it is preferable that a length of a linear viscoelastic region defined by a width of a shear stress corresponding to a strain region with the loss tangent from N₀ to 1.1×N₀ is less than 12 Pa. In addition, it is preferable that a viscosity measured under conditions of a temperature of 25 °C and a shear rate of 6/s is in a range of 50 Pa·s or more and 100 Pa·s or less.

### TECHNICAL FIELD

The present invention relates to a solder paste that is used in a case of joining a first member and a second member to each other by soldering.

The content of Japanese Patent Application No. 2021-200809, filed Dec. 10, 2021, is incorporated herein by reference.

### BACKGROUND ART

For example, a semiconductor device such as an LED and a power module has a structure in which a semiconductor element is joined onto a circuit layer consisting of a metal member.

In a case of joining electronic components such as semiconductor elements onto a circuit layer, methods using a solder paste as shown in Patent Documents 1 to 3 are widely used.

Here, as a method for supplying the solder paste to a joining surface, there are a printing method, a dispensing method, a pin transfer method, and the like.

### CITATION LIST

### Patent Documents

### [Patent Document 1]

Japanese Unexamined Patent Application, First Publication No. 2000-271782

### [Patent Document 2]

Japanese Patent No. 6459656

### [Patent Document 3]

Japanese Patent No. 6428339

### SUMMARY OF INVENTION

### Technical Problem

Meanwhile, the dispensing method is advantageous in that a solder paste is extruded by a cylinder, making it possible to apply the solder paste even on joining surfaces having a variety of shapes.

However, in the dispensing method, there has been a concern that an amount of the solder paste to be dispensed is likely to be unstable and a so-called air blow may occur without sufficiently dispensing the solder paste.

The present invention has been made in view of the above-described circumstances, and an object thereof is to provide a solder paste which can be stably supplied even in a case of being applied by a dispensing method.

### Solution to Problem

The present inventors have conducted intensive studies to solve the problem, and as a result, they have found that the flow properties of the solder paste are greatly affected by a loss tangent tan δ=G″/G′ which is a ratio of an elastic modulus (a storage modulus G″ in dynamic viscoelasticity measurement) to a viscosity (a loss modulus G′ in the dynamic viscoelasticity measurement) of the solder paste, making it possible to stably dispense the solder paste from the cylinder, even in the case of the dispensing method, by appropriately controlling the loss tangent.

The present invention has been made in view of the above-described findings, and the solder paste according to one aspect of the present invention is a solder paste including a metal powder, a resin, a solvent, and a thixotropic agent, in which a loss tangent at a strain of 0.01% is in a range of 0.1 or more and 0.5 or less.

According to the solder paste having this configuration, the loss tangent at a strain of 0.01% is set to 0.1 or more. Therefore, a stress required at the start of the dispensing is reduced and the solder paste can be stably dispensed. On the other hand, since the loss tangent at a strain of 0.01% is set to 0.5 or less, the shape of the applied solder paste can be maintained, and the solder paste can be stably applied.

Here, in the solder paste according to one aspect of the present invention, in a case where the loss tangent at a strain of 0.01% is denoted as N₀, it is preferable that a length of a linear viscoelastic region defined by a width of a shear stress corresponding to a strain region with the loss tangent from N₀ to 1.1×N₀ is less than 12 Pa.

In this case, since the length of the linear viscoelastic region is suppressed to less than 12 Pa, a stress required at the start of the dispensing is further reduced and the solder paste can be further stably dispensed.

In addition, in the solder paste according to one aspect of the present invention, a viscosity measured under conditions of a temperature of 25 °C and a shear rate of 6/s is preferably in a range of 50 Pa·s or more and 100 Pa·s or less.

In this case, since the viscosity measured under the conditions of a temperature of 25 °C and a shear rate of 6/s is set to be in the range of 50 Pa·s or more and 100 Pa·s or less, the solder paste can be further stably dispensed by the dispensing method.

### Advantageous Effects of Invention

According to the present invention, a solder paste that can be stably supplied even in a case of being applied by a dispensing method can be provided.

### BRIEF DESCRIPTION OF DRAWINGS

FIG. 1 is a graph showing dynamic viscoelasticity measurement of a solder paste according to an embodiment of the present invention.

FIG. 2 is a graph showing a relationship between a loss tangent and a strain of a solder paste of Inventive Example 3 in Examples.

FIG. 3 is a graph showing a relationship between a loss tangent and a strain of a solder paste of Comparative Example in Examples.

### DESCRIPTION OF EMBODIMENTS

Hereinafter, the solder paste according to an embodiment of the present invention will be described.

The solder paste according to the present embodiment is used in a case of joining the first member and the second member to each other by soldering. For example, the solder paste is used in a case of joining a semiconductor element (second member) as an electronic component to a circuit layer (first member) of an insulating circuit substrate.

The solder paste according to the present embodiment includes a metal powder, a resin, a solvent, and a thixotropic agent. Furthermore, the composition may include an activator, as necessary.

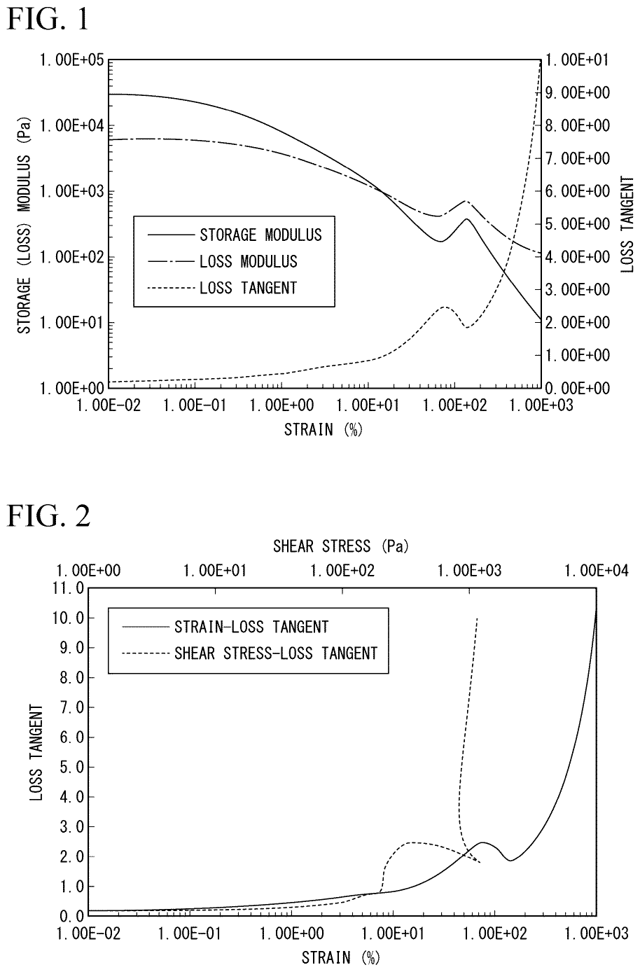

Moreover, in the solder paste according to the present embodiment, the loss tangent at a strain of 0.01% in the dynamic viscoelasticity measurement is in a range of 0.1 or more and 0.5 or less. The results of the dynamic viscoelasticity measurement of the solder paste according to the present embodiment are shown in FIG. 1.

The loss tangent is the ratio of the elasticity (a storage modulus G″ in dynamic viscoelasticity measurement) to the viscosity (a loss modulus G′ in the dynamic viscoelasticity measurement) of the solder paste.

Loss tangent tan δ=G″/G′

Here, in a case where the loss tangent at a strain of 0.01% is less than 0.1, there is a concern that a stress required at the start of the dispensing increases and the solder paste cannot be stably dispensed. On the other hand, in a case where the loss tangent at a strain of 0.01% is more than 0.5, there is a concern that the shape of the applied solder paste cannot be maintained and there may be a variation in the applied solder paste.

Therefore, in the present embodiment, the loss tangent at a strain of 0.01% is set to be in a range of 0.1 or more and 0.5 or less.

Here, the loss tangent at a strain of 0.01% is still more preferably 0.2 or more. In addition, the loss tangent at a strain of 0.01% is still more preferably 0.3 or less.

Furthermore, in a case where the equivalent circle diameter of a dispensing port of a cylinder that dispenses the solder paste is 1.0 mm or less, it is preferable that the loss tangent at a strain of 0.01% is 0.3 or less.

Here, in the solder paste of the present embodiment, in a case where the loss tangent at a strain of 0.01% is denoted as N₀, it is preferable that a length of a linear viscoelastic region defined by a width of a shear stress corresponding to a strain region with the loss tangent from N₀ to 1.1×N₀ is less than 12 Pa.

In the solder paste of the present embodiment, by setting the length of the above-described linear viscoelastic region to less than 12 Pa, a stress required for starting the dispensing can be further reduced and it is possible to stably dispense the solder paste.

Furthermore, it is still more preferable that the length of the linear viscoelastic region is 10 Pa or less.

In addition, in the solder paste according to the present embodiment, the viscosity measured under the conditions of a temperature of 25 °C and a shear rate of 6/s is preferably in a range of 50 Pa·s or more and 100 Pa·s or less.

In the solder paste of the present embodiment, the solder paste can be further stably dispensed by the dispensing method by setting the above-described viscosity to be in a range of 50 Pa·s or more and 100 Pa·s or less. The above-described viscosity is still more preferably in a range of 50 Pa·s or more and 80 Pa·s or less.

Examples of the metal powder included in the solder paste of the present embodiment include Sn—Ag—Cu, Au—Sn, Sn—Cu, Pb—Sn, and Au—Ge. These metal powders may be alloy powders or may be mixed powders. In the present embodiment, the metal powder is a mixed powder of an Au powder and an Sn powder.

As the resin included in the solder paste of the present embodiment, for example, a polymerized rosin, a natural rosin, a purified rosin, isobornylcyclohexanol, a rosin ester, or the like is used.

As the solvent included in the solder paste of the present embodiment, for example, solvents such as an alcohol, a ketone, an ester, an ether, aromatic solvents, hydrocarbons, terpene-based solvents, and terpenoid-based solvents are used. Specifically, benzyl alcohol, ethanol, ethyl alcohol, isopropyl alcohol, butanol, diethylene glycol, ethylene glycol, ethyl cellosolve, butyl cellosolve, butyl carbitol, isopropyl alcohol, ethyl acetate, butyl acetate, butyl benzoate, diethyl adipate, dodecane, tetradecene, α-terpineol, 2-methyl 2,4-pentanediol, 2-ethyl-1,3-hexanediol, toluene, xylene, propylene glycol monophenyl ether, diethylene glycol monohexyl ether, ethylene glycol monobutyl ether, diethylene glycol monobutyl ether, diisobutyl adipate, hexylene glycol, cyclohexanedimethanol, 2-terpinyloxyethanol, 2-dihydroterpinyloxyethanol, citral, linalool, limonene, carvacrol, pinene, farnesene, ethyl myristate, and the like are used alone or in a mixture thereof.

As the thixotropic agent included in the solder paste of the present embodiment, for example, a hardened castor oil, a hydrogenated castor oil, a carnauba wax, amides, hydroxy fatty acids, dibenzylidene sorbitol, bis(p-methylbenzylidene)sorbitol, a beeswax, stearic acid amide, and hydroxystearic acid ethylene bisamide are used alone or in a mixture thereof.

In a case where the solder paste of the present embodiment includes an activator, for example, fatty acids such as adipic acid, caprylic acid, lauric acid, myristic acid, palmitic acid, stearic acid, and behenic acid, hydroxy fatty acids such as 1,2-hydroxystearic acid, an antioxidant, a surfactant, an amine, or the like can be added and used as the activator.

Here, the content of the metal powder is preferably in a range of 75% by mass or more and 95% by mass or less. The content of the metal powder is still more preferably in a range of 80% by mass or more and 92% by mass or less.

The content of the resin is preferably in a range of 1.0% by mass or more and 10.0% by mass or less. The content of the resin is still more preferably in a range of 4.0% by mass or more and 8.0% by mass or less.

The content of the solvent is preferably in a range of 1.0% by mass or more and 10.0% by mass or less. The content of the solvent is still more preferably in a range of 4.0% by mass or more and 8.0% by mass or less.

The content of the thixotropic agent is preferably in a range of 0.1% by mass or more and 2.0% by mass or less. The content of the thixotropic agent is still more preferably in a range of 0.1% by mass or more and 1.5% by mass or less.

The content of the activator is preferably in a range of 0% by mass or more and 3.0% by mass or less. The content of the activator is preferably in a range of 0% by mass or more and 2.0% by mass or less.

Furthermore, each content is a value in a case where the solder paste is 100% by mass.

In a case where the content of the flux including the resin, the solvent, the thixotropic agent, and the activator is set to 100% by mass, the content of the resin is preferably 40% by mass or more.

Next, a method for producing a solder paste of the present embodiment will be described.

First, a part of the thixotropic agent is added to the solvent, stirred, and heated to a temperature higher than a dissolution temperature of the thixotropic agent. Thereafter, a resin and an activator are added thereto and mixed under stirring to obtain a mixture. Then, in a process of cooling the obtained mixture, the remaining thixotropic agent is added.

In the thixotropic agent added before heating, crystal nuclei grow during the heating process and the crystal grains of the thixotropic agent become coarse. On the other hand, the crystal grains of the thixotropic agent added during cooling are not coarsened. In this manner, by controlling the state of the crystal grains of the thixotropic agent included in the solder paste, it is possible to adjust the viscoelastic characteristics (loss tangent) of the solder paste.

Furthermore, in a case where the total amount of the thixotropic agent to be used is set to 100%, the proportion of the thixotropic agent to be added before heating is preferably in a range of 40% or more and 95% or less, and the proportion of the thixotropic agent to be added during cooling is preferably in a range of 5% or more and 60% or less.

In a case where the total amount of the thixotropic agent to be used is set to 100%, the proportion of the thixotropic agent to be added before heating is more preferably in a range of 50% or more and 80% or less, and the proportion of the thixotropic agent to be added during cooling is still more preferably in a range of 20% or more and 50% or less.

In a case where a part of the thixotropic agent is added to the solvent, stirred, and heated, it is preferable that the heating is performed to a temperature higher than the dissolution temperature of the thixotropic agent by 10 °C to 20 °C. The temperature at the time of adding the remaining thixotropic agent is preferably a temperature lower than the dissolution temperature of the thixotropic agent by 5 °C to 10 °C.

With the solder paste according to the present embodiment having the configuration as described above, the loss tangent at a strain of 0.01% is set to 0.1 or more, whereby a stress required at the start of the dispensing is reduced and the solder paste can be stably dispensed. On the other hand, since the loss tangent at a strain of 0.01% is set to 0.5 or less, the shape of the applied solder paste can be maintained and the solder paste can be stably applied.

In the solder paste according to the present embodiment, in a case where the loss tangent at a strain of 0.01% is denoted as N₀, it is preferable that a length of a linear viscoelastic region defined by a width of a shear stress corresponding to a strain region with the loss tangent from N₀ to 1.1×N₀ is less than 12 Pa.

In this case, since the length of the linear viscoelastic region is suppressed to less than 12 Pa, a stress required at the start of the dispensing is further reduced and the solder paste can be further stably dispensed.

In addition, in the solder paste according to the present embodiment, the viscosity measured under the conditions of a temperature of 25 °C and a shear rate of 6/s is preferably in a range of 50 Pa·s or more and 100 Pa·s or less.

In this case, since the viscosity measured under the conditions of a temperature of 25 °C and a shear rate of 6/s is set to be in the range of 50 Pa·s or more and 100 Pa·s or less, the solder paste can be further stably dispensed by the dispensing method.

Hereinabove, the embodiment of the present invention has been described. However, the present invention is not limited thereto and can be suitably modified without departing from the technical idea of the invention.

For example, in the present embodiment, a description has been made that the semiconductor element (second member) is joined to the circuit layer (first member) of the insulating circuit substrate as an electronic component. However, the present invention is not limited thereto, and the first member and the second member are not particularly limited.

In the present embodiment, in the method for producing a solder paste, a description has been made that a part of the thixotropic agent is added to the solvent, stirred, and heated, and the resin and the activator are added thereto and mixed under stirring to obtain a mixture. However, the present invention is not limited thereto, and a part of the thixotropic agent, the resin, and the activator may be added to the solvent, then heated, and mixed under stirring to obtain a mixture.

### EXAMPLES

Hereinafter, the results of evaluation tests carried out to evaluate the action and effect of the solder paste according to the present invention will be described.

First, as shown in Table 1, a resin, a solvent, and a thixotropic agent were mixed, heated up to 150 °C, stirred, then cooled to room temperature, and mixed with a metal powder to manufacture various solder pastes.

Furthermore, as shown in Table 1, the thixotropic agent was added in two parts, before heating and at the start of cooling after heating.

For the obtained various solder pastes, the loss tangent, the length of the linear viscoelastic region, the viscosity, and the dispersion property were evaluated as follows.

### (Loss Tangent and Length of Linear Viscoelastic Region)

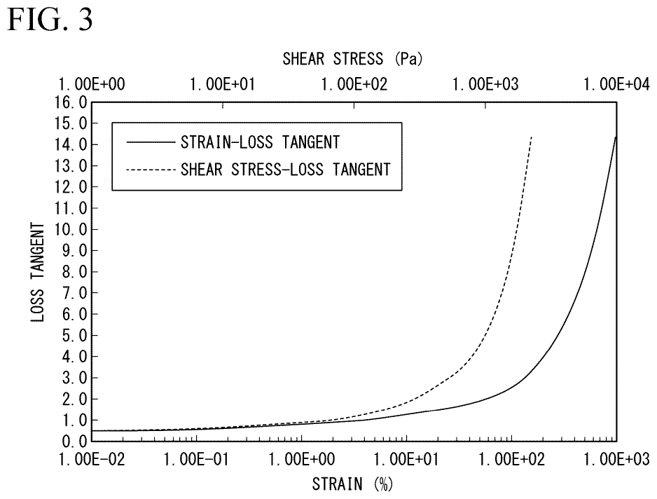

For the obtained solder paste, the viscoelastic characteristics were measured under the following conditions, using a viscoelasticity measuring device, and the loss tangent N₀ at a strain of 0.01% and the length of the linear viscoelastic region (shear stress value with the loss tangent from N₀ to 1.1×N₀) were calculated. The measurement results of Inventive Example 3 are shown in FIG. 2 and the measurement results of Comparative Example are shown in FIG. 3.
Viscoelasticity measuring device: Rheometer (model number: MCR301) manufactured by Anton Paar GmbH
Measurement part temperature of viscoelasticity measuring device: 25 °C
Rotation speed (frequency) of plate of viscoelasticity measuring device: 1 Hz
Measurement tool: PP25
Gap: 0.3 mm
Sample volume: 0.15 mL
Measurement mode: Strain dispersion

### (Viscosity)

With regard to the obtained solder paste, a viscosity was measured under the following conditions, using a viscometer.
Measurement device: Micro spiral viscometer PCU-02V manufactured by Malcom Co., ltd.
Measurement temperature: 25 °C±0.11 °C
Measurement speed: 10 rpm (shear rate 6/s)
Waiting time before measurement: 600 s
Sample volume: 0.2 mL

### (Dispersion Property)

With regard to the obtained solder paste, 1,000-dot application was performed onto a surface of an Si substrate by a dispensing method with an application diameter of 800 μm as a target, using a device shown below. A diameter of the applied paste was measured with a one-shot 3D shape measuring machine (VR-5000, manufactured by KEYENCE Corporation), and a standard deviation a of the diameters of 1,000 dots was calculated.
Dispenser: ML-606GX (manufactured by MUSASHI ENGINEERING, Inc.)
Robot: SHOTMASTER 300 LIX
Pellet container: 5 cc Syringe (PSY-5E) manufactured by MUSASHI ENGINEERING, Inc.

A case where the paste was not dispensed during the continuous application of 1,000 dots, and the application of 1,000 dots was not able to be performed was defined as “D”, a case where the standard deviation a of the diameters of 1,000 dots was 20 μm or more was defined as “C”, a case where the standard deviation a of the diameters of 1,000 dots was 10 μm or more and less than 20 μm was defined as “B”, and a case where the standard deviation a of the diameters of 1,000 dots was less than 10 μm was defined as “A”.

TABLE 1

| | | | | | | | | | | Thixotropic agent | | | |
|---|---|---|---|---|---|---|---|---|---|---|---|---|---|
| | | | | | | | | | | | | Addition | |
| | | | | | | | | | | | | proportion (%) | |
| | | Metal powder | | Resin | | Solvent | | Activator | | | Total | | At |
| | | | Content | | Content | | Content | | Content | | content | | start |
| | | | (% by | | (% by | | (% by | | (% by | | (% by | Before | of |
| | | Material | mass) | Material | mass) | Material | mass) | Material | mass) | Material | mass) | heating | cooling |
| Inventive | 1 | SAC305 | 88.0 | Isobornyl- | 5.8 | α- | 5.8 | None | 0.0 | Bis(p-methyl- | 0.4 | 80.0 | 20.0 |
| Example | | | | cyclohexanol | | Terpineol | | | | benzyli- | | | |
| | | | | | | | | | | dene)sorbitol | | | |
| | 2 | Au-22% | 85.0 | Polymerized | 6.5 | Ethyl | 6.0 | Adipic | 1.0 | Stearic acid | 1.5 | 66.7 | 33.3 |
| | | by mass | | rosin | | myristate | | acid | | amide | | | |
| | | Sn | | | | | | | | | | | |
| | 3 | Sn-0.7% | 82.0 | Rosin | 9.6 | 2-Ethyl-1,3- | 7.6 | None | 0.0 | Bis(p-methyl- | 0.8 | 50.0 | 50.0 |
| | | by mass | | ester | | hexanediol | | | | benzyli- | | | |
| | | Cu | | | | | | | | dene)sorbitol | | | |
| | 4 | Pb-5% | 83.0 | Rosin | 9.0 | 2-Ethyl-1,3- | 7.4 | None | 0.0 | Bis(p-methyl- | 0.6 | 75.0 | 25.0 |
| | | by mass | | ester | | hexanediol | | | | benzyli- | | | |
| | | Sn | | | | | | | | dene)sorbitol | | | |
| | 5 | Sn-0.7% | 82.0 | Rosin | 9.6 | 2-Ethyl-1,3- | 7.6 | None | 0.0 | Bis(p-methyl- | 0.8 | 40.0 | 60.0 |
| | | by mass | | ester | | hexanediol | | | | benzyli- | | | |
| | | Cu | | | | | | | | dene)sorbitol | | | |
| | 6 | SAC305 | 91.0 | Polymerized | 4.0 | α- | 3.7 | Adipic | 0.5 | Stearic acid | 0.8 | 66.3 | 33.7 |
| | | | | rosin | | Terpineol | | acid | | amide | | | |
| | 7 | Au-20% | 91.0 | Rosin | 4.0 | 2-Ethyl-1,3- | 4.0 | Stearic | 0.5 | Hardened | 0.5 | 66.0 | 34.0 |
| | | by mass | | ester | | hexanediol | | acid | | castor oil | | | |
| | | Sn | | | | | | | | | | | |
| | 8 | Au-12% | 90.0 | Isobornyl- | 5.0 | Ethyl | 4.5 | None | 0.0 | Stearic acid | 0.5 | 90.0 | 10.0 |
| | | by mass | | cyclohexanol | | myristate | | | | amide | | | |
| | | Ge | | | | | | | | | | | |
| | 9 | Au-12% | 90.0 | Isobornyl- | 5.0 | Ethyl | 4.5 | None | 0.0 | Stearic acid | 0.5 | 95.0 | 5.0 |
| | | by mass | | cyclohexanol | | myristate | | | | amide | | | |
| | | Ge | | | | | | | | | | | |

| Comparative | Au-22% | 88.0 | Polymerized | 6.0 | Diethylene | 4.0 | Stearic | 1.0 | Hardened | 1.0 | 100.0 | 0.0 |
|---|---|---|---|---|---|---|---|---|---|---|---|---|
| Example | by mass | | rosin | | glycol | | acid | | castor oil | | | |
| | Sn | | | | monohexyl | | | | | | | |
| | | | | | ether | | | | | | | |

SAC305: Sn-3.0% by mass Ag-0.5% by mass Cu

TABLE 2

| | | Length of linear | | |
|---|---|---|---|---|
| | Loss | viscoelastic region | Viscosity | Dispersion |
| | tangent | (Pa) | (Pa · s) | property |
| Inventive | 0.27 | 5.2 | 52.5 | A |
| Example 1 | | | | |
| Inventive | 0.48 | 9.4 | 85.5 | B |
| Example 2 | | | | |
| Inventive | 0.26 | 11.7 | 75.2 | B |
| Example 3 | | | | |
| Inventive | 0.16 | 11.5 | 75.7 | B |
| Example 4 | | | | |
| Inventive | 0.31 | 10.6 | 74.6 | C |
| Example 5 | | | | |
| Inventive | 0.32 | 14.0 | 110.0 | C |
| Example 6 | | | | |
| Inventive | 0.25 | 5.9 | 108.0 | C |
| Example 7 | | | | |
| Inventive | 0.19 | 28.2 | 94.2 | C |
| Example 8 | | | | |
| Inventive | 0.14 | 28.7 | 91.5 | C |
| Example 9 | | | | |
| Comparative | 0.60 | 10.4 | 90.0 | D |
| Example | | | | |

In Comparative Example, the loss tangent at a strain of 0.01% was set to 0.60, an air blow occurred, and the dispersion property was “D”.

On the other hand, in Inventive Examples 1 to 7, the loss tangent at a strain of 0.01% was set to be in a range of 0.1 or more and 0.5 or less, no air blow occurred, and the dispersion property was “C to A”.

In addition, in Inventive Examples 1 to 4 in which the length of the linear viscoelastic region was less than 12 Pa and the viscosity was in a range of 50 Pa·s or more and 100 Pa·s or less, the variation in the diameter of the paste after coating was suppressed and the dispersion property was “B to A”.

As described above, it was confirmed that according to Inventive Examples, it is possible to provide a solder paste that can be stably supplied even in a case of being applied by a dispensing method.

### INDUSTRIAL APPLICABILITY

According to the present invention, it is possible to provide a solder paste that can be stably supplied even in a case of being applied by a dispensing method.

1. A solder paste comprising:
a metal powder,
a resin;
a solvent; and
a thixotropic agent,
wherein a loss tangent at a strain of 0.01% is in a range of 0.1 or more and 0.5 or less.

2. The solder paste according to claim 1,
wherein in a case where the loss tangent at a strain of 0.01% is denoted as N₀, a length of a linear viscoelastic region defined by a width of a shear stress corresponding to a strain region with the loss tangent from N₀ to 1.1×N₀ is less than 12 Pa.

3. The solder paste according to claim 1 or 2,
wherein a viscosity measured under conditions of a temperature of 25 °C and a shear rate of 6/s is in a range of 50 Pa·s or more and 100 Pa·s or less.
